(19) United States
(12) Patent Application Publication
(10) Pub. No.: US 2022/0294267 A1
(43) Pub. Date: Sep. 15, 2022

(54) TRIANGULAR ARRANGEMENTS FOR WIRELESS POWER TRANSFER PADS

(71) Applicant: Wireless Advanced Vehicle Electrification, LLC, Salt Lake City, UT (US)

(72) Inventors: Patrice LETHELLIER, Salt Lake City, UT (US); Kelly WARDELL, Stansbury Park, UT (US); Adeel ZAHEER, West Valley, UT (US)

(21) Appl. No.: 17/742,250

(22) Filed: May 11, 2022

Related U.S. Application Data
(63) Continuation-in-part of application No. 17/551,743, filed on Dec. 15, 2021.
(60) Provisional application No. 63/149,945, filed on Feb. 16, 2021.

(51) Int. Cl. H02J 50/00; H02J 50/70; H02J 50/12; H01F 38/14; H01F 27/36; H02J 50/40; B60L 53/12

(52) U.S. Cl. CPC H02J 50/005; H02J 50/70; H02J 50/12; H01F 38/14; H01F 27/36; H02J 50/402; B60L 53/12; H02J 50/90

(57) ABSTRACT

Described herein is a wireless transfer system that includes multiple charging pads. Each of the wireless power transfer pads (WPT) includes a first winding comprising conductive wiring, the first winding positioned a distance from a center of the respective WPT pad, a second winding comprising conductive wiring, the second winding positioned the distance from the center of the WPT pad, and a third winding comprising conductive wiring, the third winding positioned the distance from the center of the WPT pad, wherein the individual windings are positioned at equal distances from the other of the three windings.

### PRIORITY CLAIM

This application is a Continuation-in-Part of U.S. application Ser. No. 17/551,743 filed Dec. 15, 2021, entitled “BI-PLANE WIRELESS POWER TRANSFER PAD”, which is a nonprovisional of U.S. Provisional Application No. 63/149,945 filed Feb. 16, 2021, entitled “BI-PLANE WIRELESS POWER TRANSFER PAD”. The above-mentioned applications are hereby incorporated by reference in their entireties as if fully set forth herein.

### GOVERNMENT SUPPORT CLAUSE

This invention was made with government support under Grant No. DE-EE0008360 awarded by the U.S. Department of Energy. The government has certain rights in the invention.

### BACKGROUND

As the world becomes more aware of the impact that the use of fossil fuels is having on the environment, the demand for environmentally friendly alternatives is increasing. In the realm of transportation, vehicles that are powered by fossil fuels are being replaced by alternatives including partially or fully electric vehicles. In some cases, entire fleets of vehicles, such as busses, are being replaced by electric vehicles. However, despite this increase in popularity, electric vehicles are subject to their own unique set of problems. For example, the range of an electric vehicle is often dependent upon the amount of charge that can be, or is, stored in a battery of that vehicle. This can be, and typically is, mitigated via the use of electric charging stations that may include wireless charging pads. Such wireless charging pads may be optimized for charging efficiency.

### SUMMARY

A wireless transfer pad system is described herein in which power is wirelessly transmitted via wireless charging pads while minimizing the emission of harmful electromagnetic fields. In such a system, windings that include coils of conductive wiring are arranged in a triangular shape. Particularly, the windings may be arranged such that an alternating current is provided to the windings out of phase such that power transfer may be conducted while minimizing the emission of electromagnetic fields.

In some embodiments, A wireless power transfer (“WPT”) pad comprising a first winding comprising conductive wiring, the first winding positioned a distance from a center of the WPT pad, a second winding comprising conductive wiring, the second winding positioned the distance from the center of the WPT pad, and a third winding comprising conductive wiring, the third winding positioned the distance from the center of the WPT pad, wherein the individual windings are positioned at equal distances from the other of the three windings.

A wireless charging system comprising at least one charging pad, the at least one charging pad comprising three windings of conductive wire arranged in a triangular shape, the three windings of conductive wire configured to wirelessly transmit or receive power, individual windings of the three windings configured to at least partially cancel out an electromagnetic field generated by the other of the three windings.

The foregoing, together with other features and embodiments will become more apparent upon referring to the following specification, claims, and accompanyinu drawings. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

In order that the advantages of the embodiments will be readily understood, the detailed description includes reference to specific embodiments that are illustrated in the appended drawings. Understanding that these drawings depict only example embodiments and are not therefore to be considered to be limiting of its scope, the embodiments will be described and explained with additional specificity and detail through the use of the accompanying drawings, in which:

FIG. 1 is a schematic block diagram illustrating an example system with a wireless power transfer (“WPT”) pad in accordance with at least one embodiment;

FIG. 2A is a schematic block diagram illustrating an example power converter apparatus in accordance with at least one embodiment;

FIG. 2B is a schematic block diagram illustrating an example power converter apparatus with two resonant converters feeding windings of one or more WPT pads in accordance with at least one embodiment;

FIG. 2C is a schematic block diagram illustrating an example power converter apparatus with three resonant converters feeding windings of one or more WPT pads in accordance with at least one embodiment;

FIG. 2D is a schematic block diagram illustrating an example power converter apparatus with four resonant converters feeding windings of one or more WPT pads in accordance with at least one embodiment;

FIG. 3A is a schematic block diagram illustrating an example secondary circuit feeding a load in accordance with at least one embodiment;

FIG. 3B is a schematic block diagram illustrating an example of two windings of a secondary pad feeding two secondary circuits, which feed a load in accordance with at least one embodiment;

FIG. 3C is a schematic block diagram illustrating an example of three windings of a secondary pad feeding three secondary circuits, which feed a load in accordance with at least one embodiment;

FIG. 3D is a schematic block diagram illustrating an example of four windings of a secondary pad feeding four secondary circuits, which feed a load in accordance with at least one embodiment;

FIG. 4 depicts a first example of a wireless transfer pad having three windings implemented in accordance with some embodiments;

FIG. 5 depicts a second example of a wireless charging pad having implemented three windings in accordance with some embodiments;

FIG. 6 depicts a triangular arrangement of windings that may be implemented within a wireless charging pad in accordance with at least some embodiments;

FIG. 7 depicts an illustration of example current outputs exhibited by systems having multiple windings in accordance with at least some embodiments;

FIG. 8 depicts an illustrative example of a wireless power charging pad that may be implemented in accordance with at least some embodiments; and

FIG. 9 depicts an example of techniques for structuring one or more windings of an upper charging pad in a manner such that the area impacted by the upper charging pad is reduced.

### DETAILED DESCRIPTION

This disclosure is directed towards a wireless charging system that includes a number of wireless charging pads (e.g., an upper and lower wireless charging pad). Each of the wireless charging pads may include three windings arranged in a triangular pattern. In some embodiments, the three windings may be positioned to form an equilateral triangle. In some embodiments, each of the windings are at an approximately equal distance from the center of the charging pad (e.g., equal to within a suitable manufacturing tolerance). In some embodiments, angles between positions of each of the windings with respect to the center of the charging pad may be approximately equal (e.g., 120 degrees to within a suitable manufacturing tolerance).

Embodiments of the disclosure provide numerous advantages over conventional systems. For example, the positioning of each of the windings within the wireless charging pad can result in an optimization (e.g., a reduction and/or a minimization) of harmful emission of electromagnetic fields within the wireless charging system. In this example, at least a portion of emissions generated by the windings in the charging pad may be canceled out by the emissions generated by the other windings in the charging pad.

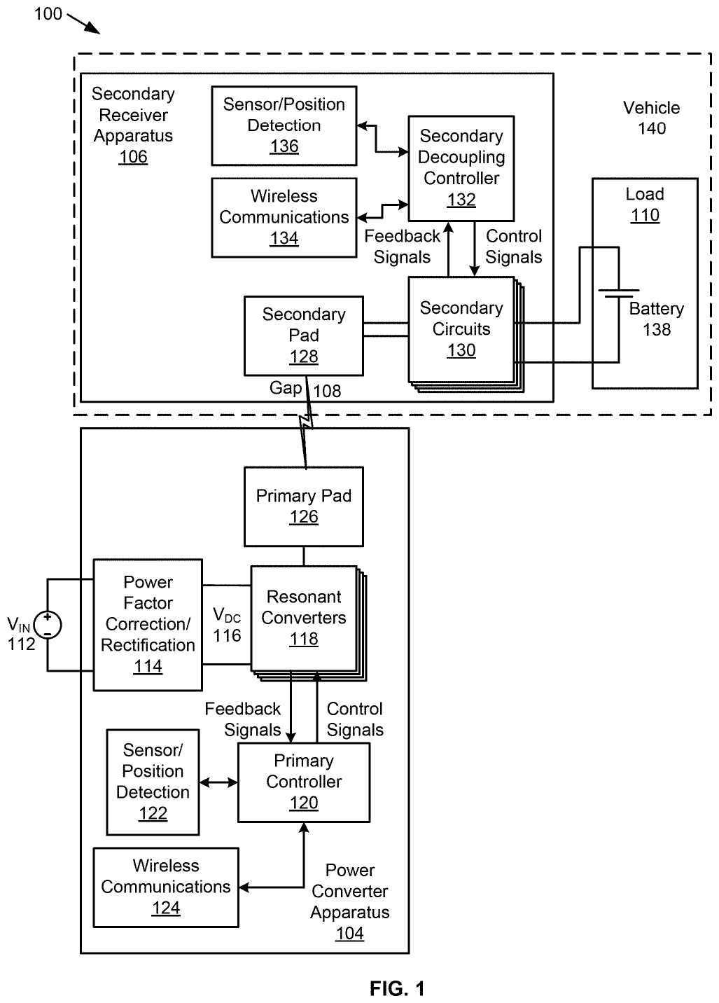

FIG. 1 is a schematic block diagram illustrating one embodiment of a system with a wireless power transfer (“WPT”) pad. The WPT system 100 includes a power converter apparatus 104 and a secondary receiver apparatus 106 separated by a gap 108, and a load 110, which are described below.

The WPT system 100 includes a power converter apparatus 104 that receives power from a power source 112 and transmits power over a gap 108 to a secondary receiver apparatus 106, which transfers power to a load 110. The power converter apparatus 104, in one embodiment, may be called a switching power converter and includes a resonant converter 118 that receives a direct current (“DC”) voltage from a DC bus 116.

In one embodiment, the power source 112 provides DC power to the DC bus 116. In another embodiment, the power source 112 is an alternating current (“AC”) power source, for example from a building power system, from a utility, from a generator, etc. and the power converter apparatus 104 includes a form of rectification to provide DC power to the DC bus 116. For example, the rectification may be in the form of a power factor correction and rectification circuit 114. In the embodiment, the power factor correction and rectification circuit 114 may include an active power factor correction circuit, such as a switching power converter. The power factor correction and rectification circuit 114 may also include a full-bridge, a half-bridge rectifier, or other rectification circuit that may include diodes, capacitors, surge suppression, etc.

The resonant converter 118 may be controlled by a primary controller 120, which may vary parameters within the resonant converter 118, such as conduction time, conduction angle, duty cycle, switching, etc. The primary controller 120 may receive information from sensors and position detection 122 within or associated with the power converter apparatus 104. The primary controller 120 may also receive information wirelessly from the secondary receiver apparatus 106.

The power converter apparatus 104 includes a primary pad 126 (i.e. a primary WPT pad) that receives power from the resonant converter 118. In some embodiments, the primary pad 126 includes two windings, three windings, four windings, etc. which are combined with a magnetic structure and the windings and magnetic structure may also be termed a “pad.” In addition, each winding may include one conductor but may also include two or more conductors in parallel. A winding may include a conductive loop that includes conductive wiring configured to carry current, the conductive wiring being arranged so that it winds around an interior area. To support the windings, the power converter apparatus 104 may include multiple resonant converters 118. In one embodiment, portions of the resonant converter 118 and primary pad 126 form a resonant circuit that enables efficient wireless power transfer across the gap 108. In another embodiment, the power converter apparatus 104 includes a switching power converter that is not a resonant converter. The gap 108, in some embodiments includes an air gap, but may also may partially or totally include other substances. For example, where the primary pad 126 is in a roadway, the gap 108 may include a resin, asphalt, concrete or other material just over the windings of the primary pad 126 in addition to air, snow, water, etc. between the primary pad 126 and a secondary pad 128 located in the secondary receiver apparatus 106. In other embodiments, the gap 108 may include water where wireless power transfer occurs under water.

The secondary receiver apparatus 106 includes a secondary pad 128 (i.e. a secondary WPT pad) connected to a secondary circuit 130 that delivers power to the load 110. In the depicted embodiment, the secondary pad 128 may include multiple windings, which may also be termed “pads.” Each winding may feed a separate secondary circuit 130 or a single secondary circuit 130. The secondary receiver apparatus 106 may also include a secondary decoupling controller 132 that controls the secondary circuit 130 and may also be in communication with sensors and/or position detection 136 and wireless communications 134 coupled with the power converter apparatus 104.

In one embodiment, the secondary receiver apparatus 106 and load 110 are part of a vehicle 140 that receives power from the power converter apparatus 104. The load 110 may include a battery 138, a motor, a resistive load, a circuit or other electrical load. For example, the WPT system 100 may transfer power to a portable computer, a consumer electronic device, to an industrial load, or other portable load that would benefit from receiving power wirelessly.

In one embodiment, the secondary circuit 130 includes a portion of resonant circuit that interacts with the secondary pad 128 and that is designed to receive power at a resonant frequency. In another embodiment, the secondary circuit 130 includes a power conditioning circuit that is not a resonant circuit. The secondary circuit 130 may also include a rectification circuit, such as a full-bridge rectifier, a half-bridge rectifier, and the like. In another embodiment, the secondary circuit 130 includes a power converter of some type that receives power from the resonant circuit/rectifier and actively controls power to the load 110. For example, the secondary circuit 130 may include a switching power converter. In another embodiment, the secondary circuit 130 includes passive components and power to the load 110 is controlled by adjusting power in the power converter apparatus 104. In another embodiment, the secondary circuit 130 includes an active rectifier circuit that may receive and transmit power. One of skill in the art will recognize other forms of a secondary circuit 130 appropriate for receiving power from the secondary pad 128 and delivering power to the load 110.

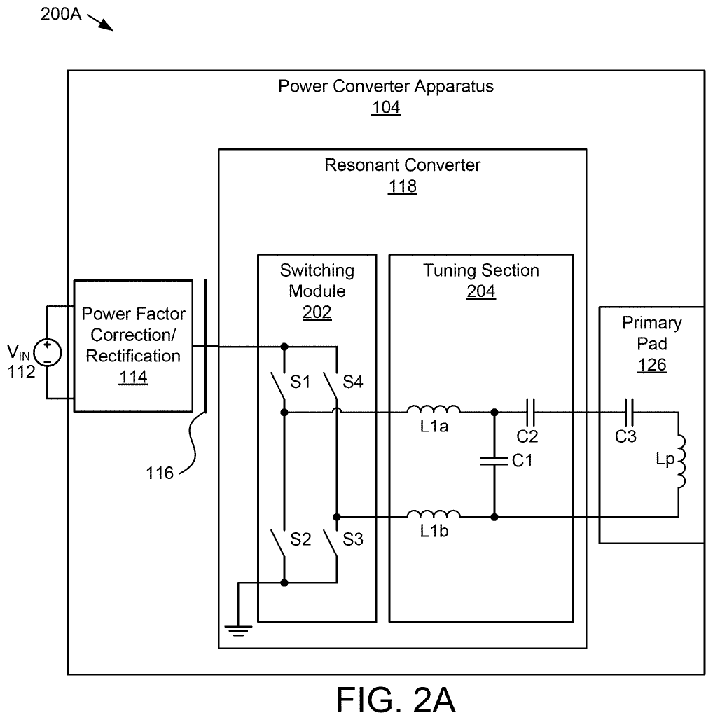

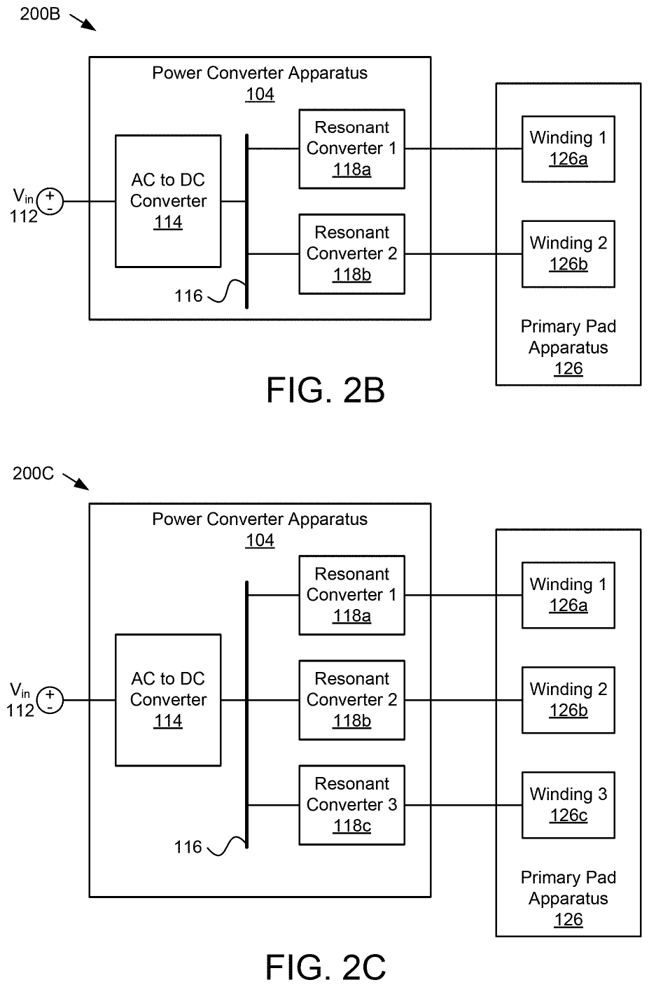

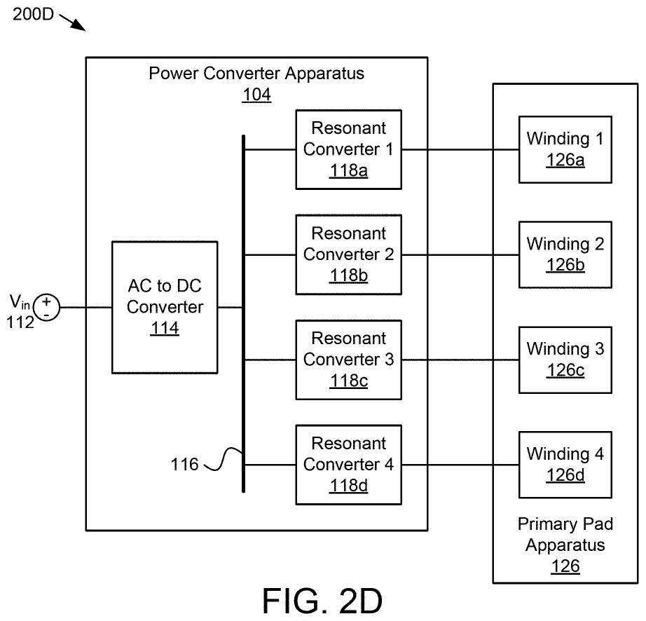

The resonant converter 118, in one embodiment, includes an active switching section coupled with a resonant circuit formed with components of the resonant converter 118 and the primary pad 126. The resonant converter 118 is described in more detail with regard to FIGS. 2A-2D.

FIG. 2A is a schematic block diagram illustrating one embodiment 200A of a power converter apparatus 104. The power converter apparatus 104 is connected to a power source 112 and includes a power factor correction and rectification circuit 114 connected to a DC bus 116 feeding a resonant converter 118 connected to a primary pad 126 as described with regard to the WPT system 100 of FIG. 1.

The resonant converter 118 includes a switching module 202 and a tuning section 204. In one embodiment, the switching module 202 includes four switches configured to connect the DC bus 116 and to ground. Typically, switches S1 and S3 close while switches S2 and S4 are open and vice-versa. When switches SI and S3 are closed, the DC bus 116 is connected to a positive connection of the tuning section 204 through inductor L1a and the ground is connected to the negative connection of the tuning section 204 through inductor L1b while switches S2 and S4 are open. When switches S2 and S4 are closed, the ground is connected to the positive terminal of the tuning section 204 and the DC bus 116 is connected to the positive connection of the tuning section 204. Thus, the switching module alternates connection of the DC bus 116 and ground to the tuning section 204 simulating an AC waveform. The AC waveform is typically imperfect due to harmonics.

Typically, switches S1-S4 are semiconductor switches, such as a metal-oxide-semiconductor field-effect transistor (“MOSFET”), a junction gate field-effect transistor (“JFET”), a bipolar junction transistor (“BJT”), an insulated-gate bipolar transistor (“IGBT”) or the like. Often the switches Sl-S4 include a body diode that conducts when a negative voltage is applied. In some embodiments, the timing of opening and closing switches Sl-S4 are varied to achieve various modes of operations, such as zero-voltage switching.

The tuning section 204 of the resonant converter 118 and the primary pad 126 are designed based on a chosen topology. For example, the resonant converter 118 and primary pad 126 may form an inductor-capacitor-inductor (“LCL”) load resonant converter, a series resonant converter, a parallel resonant converter, and the like. The embodiment depicted in FIG. 2A includes an LCL load resonant converter.

Resonant converters include an inductance and capacitance that form a resonant frequency. When a switching frequency of the tuning section 204 is at or close to the resonant frequency, voltage with the tuning section 204 and primary pad 126 often increases to voltages levels higher than the voltage of the DC bus 116. For example, if the voltage of the DC bus 116 is 1 kilovolt (“kV”), voltage in the tuning section 204 and resonant converter 118 may be 3 kV or higher. The high voltages require component ratings, insulation ratings, etc. to be high enough for expected voltages.

The primary pad 126 includes capacitor C3 and inductor Lp while the tuning section 204 includes series capacitor C2. Capacitors C2 and C3 add to provide a particular capacitance that forms a resonant frequency with inductor Lp. In some embodiments, the power converter apparatus 104 includes a single series capacitor in the tuning section 204 or in the primary pad 126. While FIG. 2A is focused on the resonant converter 118 and primary pad 126, the secondary receiver apparatus 106 includes a secondary pad 128 and a secondary circuit 130 that typically includes a tuning section 204 where the inductance of the secondary pad 128 and capacitance of the tuning section 204 of the secondary circuit 130 form a resonant frequency and the secondary pad 128 and secondary circuit 130 have voltage issues similar to the primary pad 126 and resonant converter 118. In other embodiments, the tuning section 204 and primary pad 126 are not designed to produce a resonance, but instead condition voltage from the switching module 202. For example, the tuning section 204 may filter out harmonic content without filtering a switching frequency.

FIG. 2B is a schematic block diagram illustrating one embodiment 200B of a power converter apparatus 104 with two resonant converters 118a-b feeding windings 1216a-b of one or more WPT pads 126. FIG. 2B is a schematic block diagram illustrating one embodiment 201 of a power converter apparatus 104 with two resonant converters 118a-b feeding windings 126a-b of one or more primary pads 126. FIG. 2B is presented in a one-line diagram format. One of skill in the art will recognize that each line between elements represents two or more conductors. The power source 112, power factor correction and rectification circuit 114 and DC bus 116 are substantially similar to those described in the embodiment 200A of FIG. 2A. The power converter apparatus 104 includes two resonant converters 118a-b (generically or individually “118”) where each resonant converter 118 includes a switching module 202 and may include a tuning section 204. Each resonant converter 118 feed a winding (e.g. 126a) of a primary pad 126, which may include multiple windings 126a-b. A resonant converter (e.g. 118a) may feed an individual primary pad 126.

FIG. 2C is a schematic block diagram illustrating one embodiment 200C of a power converter apparatus 104 with three resonant converters 118a-c feeding three windings 126a-c of one or more WPT pads 126. The embodiment 200C is substantially similar to the power converter apparatus 104 of FIG. 2B except with three resonant converters 118a-c and windings 126a-c instead of two. In some embodiments, the resonant converters 118a-c produce waveforms that are offset by 120 degrees, which produces a ripple in the primary pad 126 that is minimized due to cancelling effects caused by offset of the waveforms from the resonant converters 118a-c.

FIG. 2D is a schematic block diagram illustrating one embodiment 200D of a power converter apparatus 104 with four resonant converters 118a-d feeding four windings 126a-d of one or more WPT pads 126. The embodiment 200D is substantially similar to the power converter apparatuses 104 of FIG.s 2B or 2C except with four resonant converters 118a-d and windings 126a-d instead of two or three. In some embodiments, the resonant converters 118a-d produce waveforms that are offset by 90 degrees, which produces a ripple in the primary pad 126 that is minimized due to cancelling effects caused by offset of the waveforms from the resonant converters 118a-d.

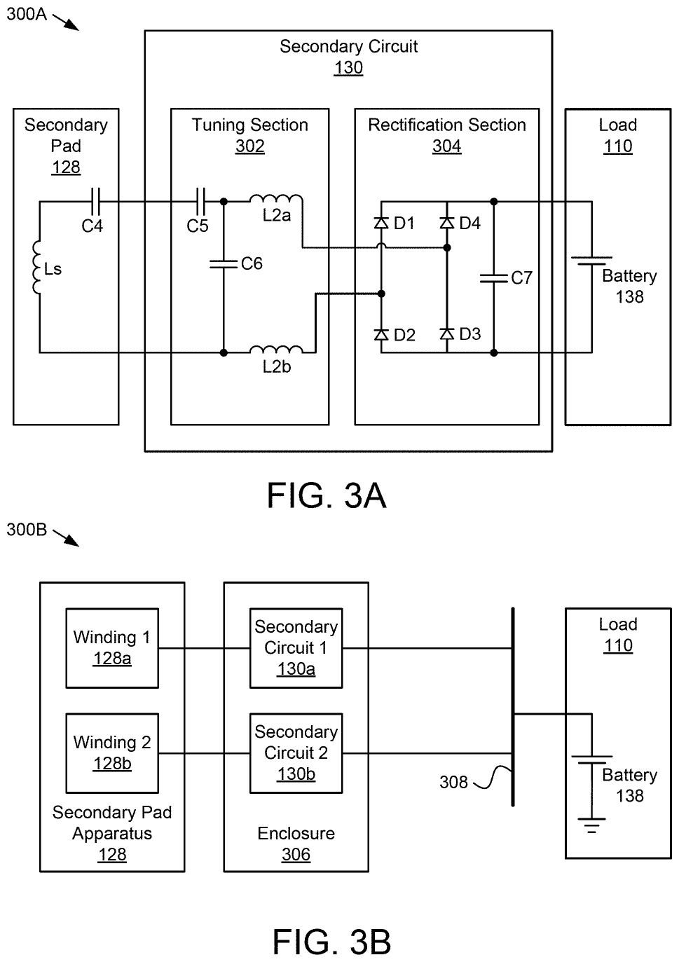

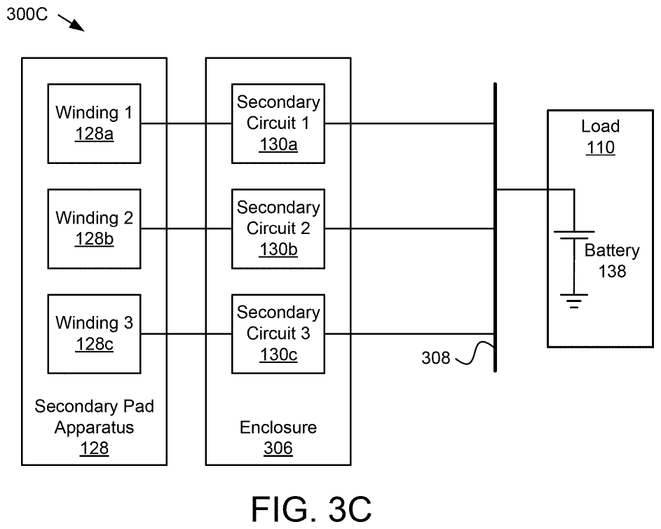

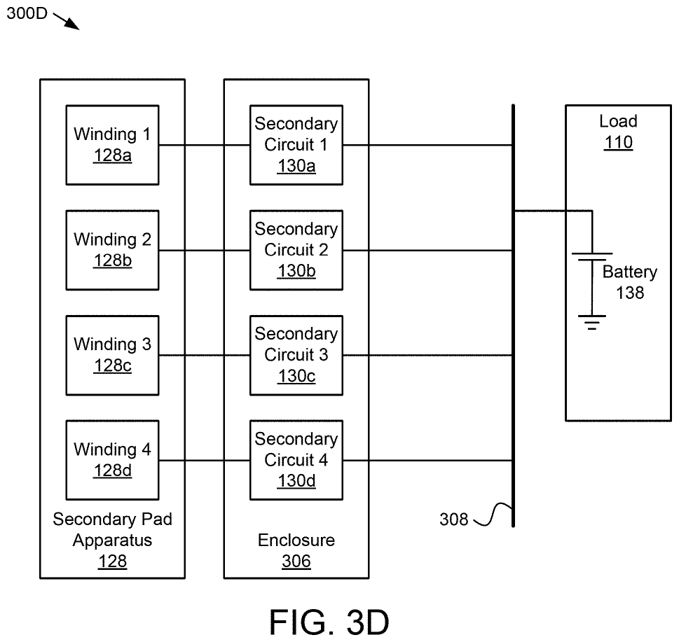

FIG. 3A is a schematic block diagram illustrating one embodiment 300A of a secondary circuit 130 feeding a load 110. A secondary pad 128 feeds a tuning section 302 within the secondary circuit 130 and the tuning section 302 feeds a rectification section 304 in the secondary circuit 130, which feeds a load 110.

The secondary pad 128 includes one or more windings arranged to receive power from a primary pad 126. The secondary pad 128 may include a magnetic structure and windings arranged in a pattern that efficiently receives power from the primary pad 126. In one embodiment, the secondary pad 128 mirrors the primary pad 126 transmitting power. In another embodiment, the secondary pad 128 differs from the primary pad 126. For example, the primary pad 126 and secondary pad 128 may be in the form of a WPT pad with vertical sections and a biplane WPT pad as described below. Typically, the secondary pad 128 includes an inductance Ls formed as a result of the windings and the magnetic structure of the secondary pad 128. In one embodiment, the secondary pad 128 includes a capacitor C4. In some embodiments, the secondary pad 128 includes multiple windings with associated inductances Ls and capacitors Cs arranged in parallel or series.

The tuning section 302 includes one or more capacitors C5, C6 and inductors L2a, L2b that are arranged to form a resonant circuit with the secondary pad 128 with a resonant frequency. In some embodiments, capacitor C6 is not present. In one embodiment, the resonant frequency matches a resonant frequency of the primary pad 126 transmitting power. Typically, a resonant frequency is formed between the inductor Ls of the secondary pad 128 and series capacitors C4 and C5 of the secondary pad 128 andlor tuning section 302. In some embodiments, the secondary pad 128 or the tuning section 302 include a single series capacitor C4 or C5. Other capacitors (e.g. C6) and inductors (e.g. L2a, L2b) may form a low pass filter to reduce voltage ripple at the resonant frequency. In other embodiments, a low-pass filter is included after rectification elements in the rectification section 304. For example, a capacitor C7 may be included. One of skill in the art will recognize other configurations of the tuning section 302 that form a resonant tank with the secondary pad 128 and pass energy to the rectification section 304 or another suitable circuit. In other embodiments, the secondary pad 128 does not transfer power at or near a resonant frequency and the inductances and capacitances differ from the secondary pad 128 and tuning section 302 depicted.

A rectification section 304 includes diodes, switches, or other rectification elements to convert alternating current (“AC”) power to direct current (“DC”) power. The rectification section 304 depicted in FIG. 3 includes a full bridge rectifier with four diodes D1-D4. In some embodiments, the diodes D1-D4 are replaced with active elements, such as switches, which may be used to reduce harmonics, reduce power consumption, and the like. For example, the rectification section 304 may include a switching power converter that controls an output voltage to the load 110.

The load 110, in one embodiment is a battery 138. In other embodiments, the load 110 may include other components, such as a motor, a resistive load, electronics, and the like. In one embodiment, the secondary pad 128, secondary circuit 130 and load 110 are part of a vehicle 140. In other embodiments, the secondary pad 128, secondary circuit 130 and load 110 are part of a computing device, a smartphone, and the like.

FIG. 3B is a schematic block diagram illustrating one embodiment 300B of two windings 128a-b of a secondary pad 128 feeding two secondary circuits 130a-b, which feed a load 110. The secondary circuits 130a-b, in one embodiment, may be in one or more enclosures 306 and feed a secondary DC bus 308, which feeds the load 110. A secondary pad 128 with two windings 128a-b is advantageous to increase power output and two windings 128a-b may also be used in determining alignment. The secondary pad 128, in some embodiments, is similar to the WPT pad depicted in FIG.s 4 and 5.

FIG. 3C is a schematic block diagram illustrating one embodiment 300C of three windings 128a-c of a secondary pad 128 feeding three secondary circuits 130a-c, which feed a load 110. As with the embodiment 300B of FIG. 3B, the secondary circuits 130a-c, in one embodiment, may be in one or more enclosures 306 and feed a secondary DC bus 308, which feeds the load 110. A secondary pad 128 with three windings 128a-c is advantageous to be used in a three-phase circuit to increase power output and to decrease noise due to the ripple cancelling effects of three-phase power.

FIG. 3D is a schematic block diagram illustrating one embodiment 300D of four windings 128a-d of a secondary pad 128 feeding four secondary circuits 130a-d, which feed a load 110. As with the embodiment 300B of FIG. 3B, the secondary circuits 130a-d, in one embodiment, may be in one or more enclosures 306 and feed a secondary DC bus 308, which feeds the load 110. A secondary pad 128 with four windings 128a-d is advantageous to be used in a single-phase or four-phase system to increase power output and to decrease noise due to ripple cancelling effects of offset waveforms.

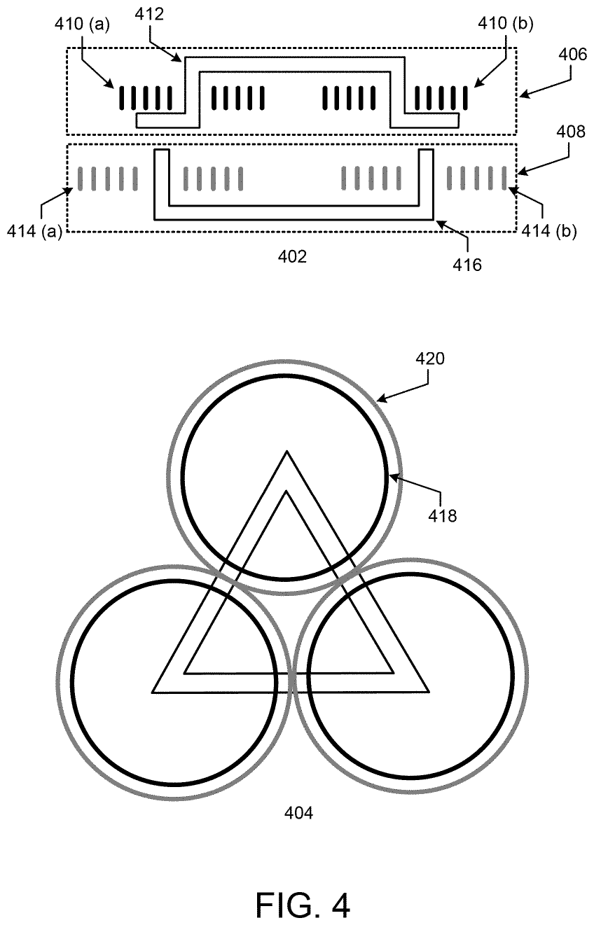

FIG. 4 depicts a first example of a wireless transfer pad having three windings implemented in accordance with some embodiments. Depicted in FIG. 4 are multiple views of the exemplary charging pad. Particularly, depicted herein are a cross sectional profile view 402 of the wireless transfer pad and a top-down view 404 of the wireless transfer pad.

In embodiments, the wireless transfer pad may include both an upper charging pad 406 and a lower charging pad 408. The upper charging pad may be installed within an electric vehicle in order to receive wireless power transferred from a lower charging pad. The lower charging pad may be configured such that the electric vehicle can be positioned over it to receive wireless transfer of power. For example, the lower charging pad may be embedded within a roadway such that an electric vehicle can be parked over it.

Each of the upper charging pad and the lower charging pad may include a number of windings (e.g., inductive coils) and a magnetic structure (e.g., a ferrite core). For example, the upper charging pad may include windings 410 (a) and 410 (b). Additionally, a magnetic core 412 may pass through a center opening of each of the windings 410. In another example, the lower charging pad may include windings 414 (a) and 414 (b). Additionally, a second magnetic core 416 may pass through a center opening of each of the windings 414.

In some embodiments, each of the charging pads may include three windings arranged in a triangular shape. Each of the centers of the three windings may be positioned at an approximately equal distance from each other. In these embodiments, each of the windings may be out of phase. Particularly, each of the three windings may be provided with an alternating current out of phase by 120 degrees.

As depicted, the charging pads may each generate radiation within an area of effect. In some embodiments, such an area of effect may vary by each winding. For example, an upper charging pad may exhibit a first area of effect 418 that is different from (e.g., wider than or narrower than) a second area of effect 420 exhibited by a lower charging pad. Where the windings are aligned between the upper and lower charging pads, the areas of effect may also be aligned.

Furthermore, it should be noted that the configuration may be mirrored and would still provide equivalent functionality. For example, the description/depictions corresponding to the upper charging pad might instead correspond to the lower charging pad and vice versa. Accordingly, one skilled in the art would recognize that such alternative embodiments would be considered equivalent for the purposes of this disclosure.

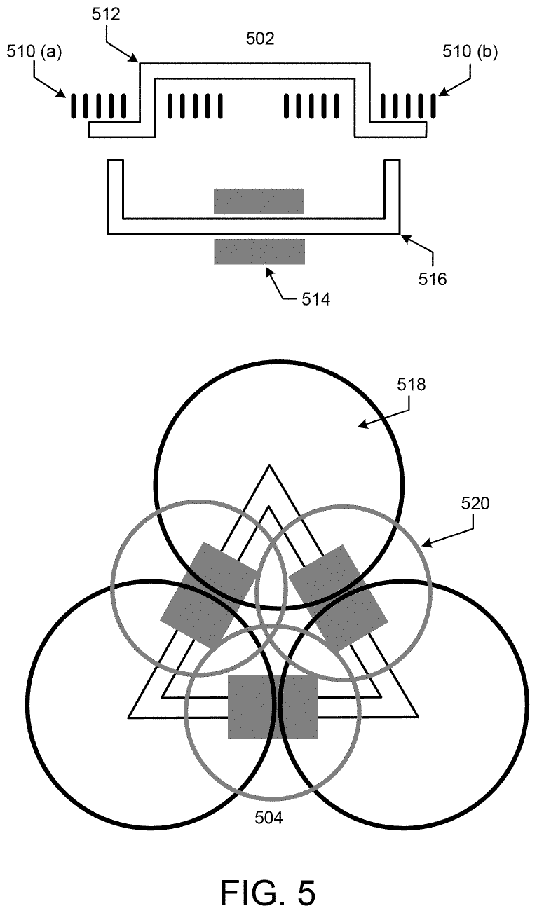

FIG. 5 depicts a second example of a wireless charging pad having implemented three windings in accordance with some embodiments. Depicted in FIG. 5 are multiple views of the exemplary charging pad. Particularly, depicted herein are a cross sectional profile view 502 of the wireless transfer pad and a top-down view 504 of the wireless transfer pad.

As described with respect to the first example of the wireless charging pad in FIG. 4, in embodiments, the wireless transfer pad may include both an upper charging pad 506 and a lower charging pad 508. The upper charging pad may be installed within an electric vehicle in order to receive wireless power transferred from a lower charging pad. The lower charging pad may be configured such that the electric vehicle can be positioned over it to receive wireless transfer of power. For example, the lower charging pad may be embedded within a roadway such that an electric vehicle can be parked over it.

Each of the upper charging pad and the lower charging pad may include a number of windings and a magnetic structure (e.g., a ferrite core). For example, the upper charging pad may include windings 510 (a) and 510 (b). Additionally, a magnetic core 512 may pass through a center opening of each of the windings 510. In another example, the lower charging pad may include a winding 514, and a second magnetic core 516 may pass through a center opening of the winding 514. In this example, the single winding may be centered on the second magnetic core. As depicted, the winding 514 may be centered on the second magnetic core 516. It should be noted that such an arrangement may allow the lower charging pad to be narrower in width, but may also result in the lower charging pad being deeper (e.g., having a greater depth) than it would otherwise be (e.g., as compared to the first example described in relation to FIG. 4 above).

In a manner similar to that described above with respect to FIG. 4, the charging pads may each generate radiation within an area of effect. In some embodiments, such an area of effect may vary by each winding. For example, an upper charging pad may exhibit a first area of effect 518 that is different from (e.g., misaligned from) a second area of effect 420 exhibited by a lower charging pad.

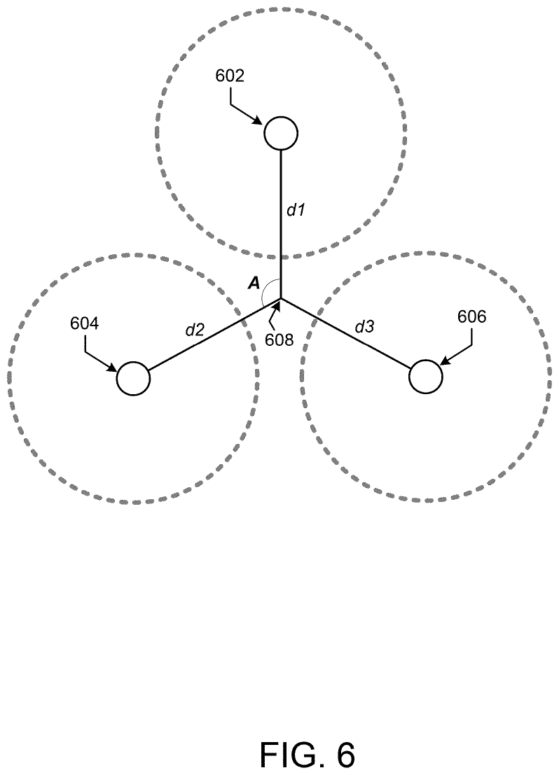

FIG. 6 depicts a triangular arrangement of windings that may be implemented within a wireless charging pad in accordance with at least some embodiments. In such an arrangement, each of three windings 602, 604, and 606 may be positioned to form an equilateral triangle. For example, winding 602 may be a distance d1 away from a center 608 of the charging pad. Likewise, winding 604 may be a distance d2 away from a center 608 of the charging pad, and winding 606 may be a distance d3 away from a center 608 of the charging pad. In this example, each of d1, d2, and d3 may be equivalent distances.

In the depicted arrangement, each of the windings may further be positioned at some angle A from each of the other windings. For example, the windings may each be positioned at an angle of 120 degrees from each other. Additionally, each of the windings may be provided an alternating current that is out of phase by 120 degrees as well.

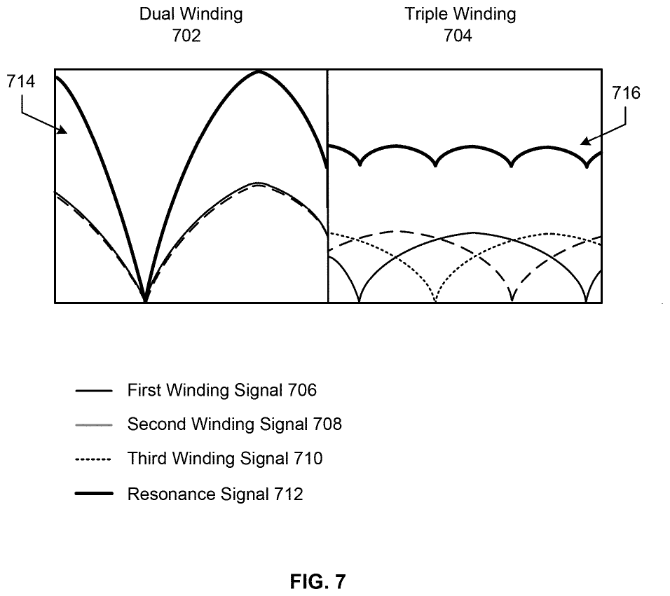

FIG. 7 depicts an illustration of example current outputs exhibited by systems having multiple windings in accordance with at least some embodiments. Such depictions include an illustration of current outputs generated by the systems as well as a resulting resonance signal that may be generated via such current outputs.

Particularly, depicted in the FIG. 7 are example current outputs generated by a charging pad having dual windings 702 and a charging pad having triple windings 704. As used herein, the term ‘winding’ refers to one or more electrical conductors arranged to enclose a volume. In at least some embodiments, the volume may contain materials with relatively low electrical conductivity and/or magnetic properties such as ferrite. When containing such materials, the winding may act as part of a solenoid and/or an electromagnet. In these depictions, the current outputs may be depicted graphically. On such a graph, lines may be depicted respectively for a first winding signal 706, a second winding signal 708, and a third winding signal 710. Additionally, a line may depict a resonance signal 712 that represents a combination of signals that may result from currents generated by the respective systems.

As would be recognized by one skilled in the art, running alternating current through multiple windings in a charging pad may result in the generation of an electromagnetic field. In embodiments in which the current is sinusoidal in nature, the resulting electromagnetic field may also be sinusoidal. Where two signals are generated by a system having dual windings that are 180 degrees out of synchronization, there is little to no ripple cancellation in the resonance signal 712. In some cases, the resonance signal may even be amplified as depicted at 714. The term ‘synchronization’ is at times used herein to refer to a presence or absence of phase shift between different periodic signals. The terms ‘out of synchronization’ and ‘out of phase’ may be used replaceably.

In contrast, where three signals are generated by a system having triple windings that are each 120 degrees out of synchronization, ripple cancellation may be maximized as depicted at 716. For example, the electromagnetic signals generated by passing currents through each of the three windings may at least partially cancel each other out to the extent that the emission of any electromagnetic field radiation is optimized (e.g., reduced and/or minimized).

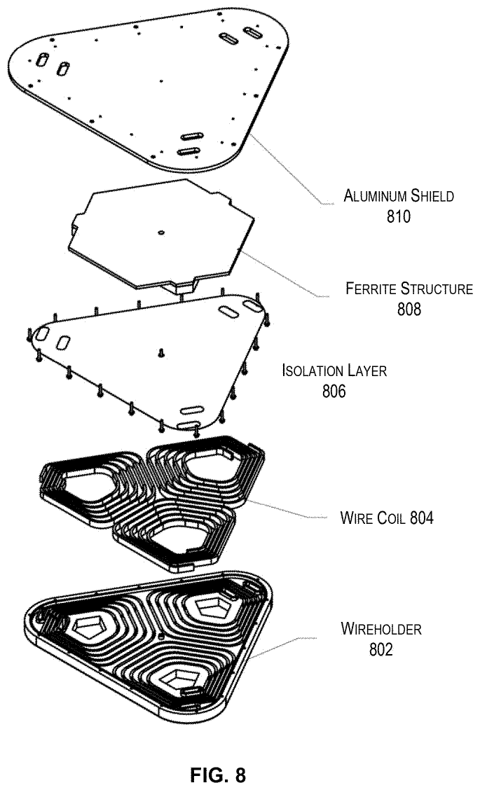

FIG. 8 depicts an illustrative example of a wireless power charging pad that may be implemented in accordance with at least some embodiments. In some embodiments, the charging pad may be constructed by assembling several layers. The layers may include a wire holder 802 configured to contain a winding (e.g., wire coil 804). The winding in this layer may be configured to wirelessly transmit power to another winding located within a charging area.

Additionally, the layers may include one or more elements intended to separate and/or provide shielding for the winding. For example, the layers may include an isolation layer 806, a ferrite structure 808, and/or an aluminum shield 810. The isolation layer may include a non-conductive and/or non-maunetic material.

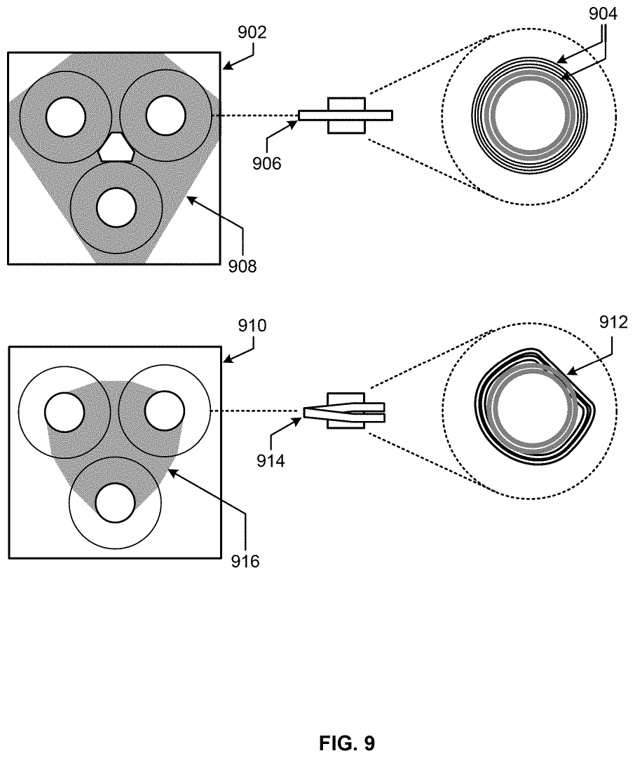

FIG. 9 depicts an example of techniques for structuring one or more windings of an upper charging pad in a manner such that the area impacted by the upper charging pad is reduced.

In a first exemplary upper charging pad 902, multiple windings 904 may be arranued in a concentric manner, such that each of the multiple windings lie along a single plane 904 and one or more windings is enveloped within another winding. Note that the phase of the current may be offset between the multiple concentric windings. As one skilled in the art would recognize, arranging the windings in this manner would result in an electromagnetic field area that is spread out over a large area. As would be recognized by one skilled in the art, such a charging pad may require a ferrite structure 908 that is relatively large.

In a second exemplary upper charging pad 910, multiple windings 912 may be arranged so that they at least partially overlap. For example, the multiple windings may lie along a single plane for a first portion and may lie along separate planes (e.g., overlapping) for a second portion as depicted at 914. This allows the overall width of the multiple windings to be reduced while potentially increasing the depth of the multiple windings. This can result in the generation of an electromagnetic field that is reduced in size from that of the first exemplary upper charging pad, enabling the ferrite structure 916 to also be reduced in size.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wireless power transfer (“WPT”) pad comprising:
a first winding comprising conductive wiring, the first winding positioned a distance from a center of the WPT pad;
a second winding comprising conductive wiring, the second winding positioned substantially the distance from the center of the WPT pad; and
a third winding comprising conductive wiring, the third winding positioned substantially the distance from the center of the WPT pad, wherein the individual windings are positioned at equal distances from the other of the three windings.

2. The wireless power transfer pad of claim 1, wherein an angle at which the first winding, second winding, and third winding are each positioned around the center of the WPT pad is substantially the same.

3. The wireless power transfer pad of claim 1, wherein each of the first winding, second winding, and third winding are provided alternating current that is out of phase.

4. The wireless power transfer pad of claim 3, wherein the current provided to each of the first winding, second winding, and third winding is out of phase by substantially 120 degrees.

5. The wireless power transfer pad of claim 1, wherein the first winding, second winding, and third winding form an equilateral triangle.

6. The wireless power transfer pad of claim 1, further comprising at least one shielding component.

7. The wireless power transfer pad of claim 6, wherein the at least one shielding component comprises a ferrite structure.

8. The wireless power transfer pad of claim 1, wherein each of the first winding, second winding, and third winding generate an electromagnetic field when provided with alternating current.

9. The wireless power transfer pad of claim 8, wherein the electromagnetic fields generated by the first winding, second winding, and third winding cancel each other out at least in part.

10. The wireless power transfer pad of claim 1, wherein the wireless power transfer pad forms either an upper charging pad or a lower charging pad within a wireless charging system.

11. A wireless charging system comprising:
at least one charging pad, the at least one charging pad comprising three windings of conductors, the three windings of conductors arranged in a triangular shape and configured to wirelessly transmit or receive power, individual windings of the three windings configured to at least partially cancel out an electromagnetic field generated by the other of the three windings.

12. The wireless charging system of claim 11, wherein the at least one charging pad comprises an upper charging pad or a lower charging pad.

13. The wireless charging system of claim 12, wherein the upper charging pad is installed within an electric vehicle.

14. The wireless charging system of claim 12, wherein the lower charging pad is embedded in a roadway.

15. The wireless charging system of claim 12, wherein the lower charging pad is connected to a power source and is configured to transmit power to the upper charging pad.

16. The wireless charging system of claim 11, wherein the triangular shape comprises a substantially equilateral triangular shape.

17. The wireless charging system of claim 11, further comprising at least one shielding component.

18. The wireless charging system of claim 17, wherein the at least one shielding component comprises a ferrite structure.
